(19) United States
(12) Patent Application Publication
(10) Pub. No.: US 2007/0069895 A1
(43) Pub. Date: Mar. 29, 2007

(54) Rfid seal tag

(76) Inventor: Soo Keong Koh, Singapore (SG)

Correspondence Address: MICHAEL BEST & FRIEDRICH, LLP, 100 E WISCONSIN AVENUE, MILWAUKEE, WI, 53202, US

(21) Appl. No.: 10/584,015

(22) PCT Filed: Dec. 1, 2004
(86) PCT No.: PCT/SG04/00389

§ 371 Date: Jun. 22, 2006

(30) Foreign Application Priority Data
Dec. 24, 2003 (SG) 200307774-0

(51) Int. Cl. G08B 13/14

(52) U.S. Cl. 340/572.1

(57) ABSTRACT

An RFID tag (400) adapted for use as a tamper-evident seal. The tag includes an RFID transponder having an integrated circuit chip (402) and an antenna (404) connected to the integrated circuit chip. When intact, the RFID transponder is able to communicate with an RFID interrogator device. The tag further includes a line of weakness (412, 414, 416, 418), such as a line of perforations, extending across at least a portion of the antenna or between the antenna and the integrated circuit chip. When the tag is broken along the line of weakness the RFID transponder is rendered unable to communicate with the RFID interrogator device.

### FIELD OF THE INVENTION

The present invention relates to electronic tracking or identification of packaged articles, and more particularly to a method and apparatus for tracking or identification of articles using radio frequency identification (RFID) tags.

### BACKGROUND OF THE INVENTION

Various technologies have been developed for tracking and identifying objects. For example, bar codes are now commonly applied to articles and such codes may be scanned optically in order to identify the articles or coded characteristics thereof, such as the price of the article. However, a disadvantage of technologies based on optical scanning is that a line of sight is required between the scanning device and the code. It is accordingly not possible to identify an object if the applied code is not oriented towards the scanning device, or if the object is contained within a box, shipping crate, or other optically opaque enclosure.

For this and other reasons, RFID technology has been developed, which enables objects to be identified without establishing a line of sight between a scanning device and an identifying tag. RFID transponders (i.e. transmitter/responders), which are often referred to simply as RFID tags, are thin radio frequency transceivers that include an integrated circuit chip plus an antenna mounted on a supporting substrate. The tag may be either active or passive, the active type including a battery for powering the transceiver whereas the passive type derives operating power from the RF signal used to interrogate the tag.

The integrated circuit chip of an RFID tag includes RF circuits, control logic and memory, while the antenna typically consists of a metallic conductor, such as copper or aluminium, formed into an inductive coil on the supporting substrate. A capacitor may additionally be formed from the metallic conductor, in order to tune the antenna resonance to a desired operating frequency. The substrate is typically a thin flexible film of plastic such as a polyester or polyimide. For example, a commonly used polyester substrate is polyethylenetherephtalate (PET). RFID tags formed in this way may be extremely thin, for example under 0.5 millimetre 0.5 millimetre inclusive of the thickness of the integrated circuit chip and under 0.1 millimetre for portions over other regions of the tag.

An interrogator device is used to read object-identifying information stored within the memory of the integrated circuit in the RFID transponder. The interrogator transmits a coded RF signal, which may be received by a transponder located within range of the transmitter, even when the tag is not in line of sight of the interrogator. Typically, the transponder reflects the incident RF carrier back to the interrogator, encoding information stored in the memory onto the carrier in the process. It is also possible, in the case of writable tags, for the information in the memory to be modified in accordance with new information encoded upon the incident RF carrier. In this way, the RFID transponder operates to receive, store and transmit object-identifying data to and from the memory within the chip.

Since the transponders are thin, they are readily integrated with further supporting materials, for example paper or a plastic such as polyvinylchloride (PVC). Accordingly, RFID tags may be deployed in the form of adhesive labels or tapes that can be easily applied to articles for tracking and identification purposes.

A particular benefit of RFID tags over other forms of identification of objects is that, because they do not rely on a line of sight for operation, they may be deployed in substantially automated tracking and identification applications. For example, interrogation devices may be mounted at fixed locations on a production or packing line, so that as articles bearing RFID tags pass by the interrogation devices they are identified so that their locations may be tracked. So long as the articles pass within radio range of the interrogators, they can be identified regardless of their orientation, the location of the RFID tags on the articles, or even whether or not they are contained within closed packaging containers. Such a tracking system enables early detection of missing or misdirected articles when, for example, an article that is expected to pass an interrogation point is not identified at the expected time, or an article is identified at an interrogation point at which it was not expected to be located.

While conventional RFID tags provide a useful means for the tracking and identification of objects, it remains the case that it is the tag, and not the object to which it is attached, that is identified by interrogation. Therefore, an RFID tracking system may be subverted by removing the article from the system, while leaving the tag in place. For example, in some cases a tagged article may be removed from a container of such articles without detection by removing the tag from the article and replacing the tag in the container. In other cases, it may be that the RFID tag is applied only to the packaging of articles, and an article may thus be removed without detection simply by removing the article from the tagged package, and leaving the package within the system. At a subsequent interrogation point, the tag will respond to the interrogation device and the system will fail to detect that the article has been removed.

Subversion of the tracking and identification system is a particular problem in logistics and associated transport industries, especially those involving the transportation or movement of relatively portable items of high value, such as, for example, watches, wine, jewellery and cellular telephone handsets. Items of this type have relatively high theft rates, and thefts may involve the removal of one or more articles from a container, such as a cardboard carton, prior to sealing or resealing of the container. Accordingly, a theft may not be discovered until the container is opened at the final destination, at which time it will be difficult to determine at which stage in the supply and transportation chain the article was removed.

One method that has been employed in an attempt to detect tampering with the contents of a container is to use a tamper resistant tape to seal the container. Such tapes are resistant to resealing, and are imprinted with a pattern that is unique to the organisation responsible for sealing the container so that any attempt to cut and reseal the tape is likely to be evident upon inspection. However, rolls of the tape may be stolen or counterfeited. In any case, tampering may still not be detected until the container is inspected closely at the destination, and there remains no way to determine whether the contents of the container have been tampered with until the container has been opened.

Accordingly, there is a need for an improved apparatus and method for use in an RFID tracking and identification system that makes it more difficult to subvert the system by separating the tags from the tracked articles.

It is to be noted that any discussion of documents, devices, acts or knowledge in this specification is included to explain the context of the invention. It should not be taken as an admission that any of the material formed part of the prior art base or the common general knowledge in the relevant art on or before the priority date of the claims herein.

### SUMMARY OF THE INVENTION

According to one aspect, the present invention provides an RFID tag for use as a tamper-evident seal, including an RFID transponder having an integrated circuit chip and an antenna connected to the integrated circuit chip, the RFID transponder being able, when intact, to communicate with an RFID interrogator device,

wherein the RFID tag has a line of weakness extending across at least a portion of the antenna or between the antenna and the integrated circuit chip, such that when the tag is broken along the line of weakness the RFID transponder is rendered unable to communicate with the RFID interrogator device.

Accordingly, an RFID tag in accordance with the invention may be affixed to a package in such a way that it is difficult to open the package in order to remove an article contained therein, without tearing the tag along the line of weakness and thus rendering the transponder inoperable. Where the package has a line of opening, such as box having a join between a lid and body of the box or a line of meeting of flaps forming a closure in the box, a tag may be affixed to the package such that the line of weakness of the tag is aligned with the line of opening of the package. It is thus difficult to open the package along the line of opening without breaking the tag along the line of weakness.

Accordingly, in another aspect the invention provides a method for sealing a package in order to enable the detection of unauthorised access to the contents of the package, including the steps of:

providing an RFID tag in accordance with the invention; and

affixing the RFID tag to the package, such that the line of weakness of the tag is aligned with a line of opening of the package,

whereby, when the package is opened along said line of opening, the tag is broken along said line of weakness.

Advantageously, if packages sealed in this manner are placed inside a larger container which is then itself sealed shut, it is then possible to interrogate the RFID tags affixed to the packages inside the container at various points in the supply and transportation chain using an RFID interrogator device. If any RFID tag fails to respond to the interrogator, it will be inferred that the corresponding article may have been tampered with or removed between successive points of interrogation.

Thus, in a further aspect the invention provides a method for detecting unauthorised tampering with, or removal of, an article stored within a container, including the steps of:

providing an RFID tag in accordance with the invention;

affixing the RFID tag to the article;

storing the article within the container;

subsequently interrogating the RFID tag using an RFID interrogator device; and

detecting unauthorised tampering with, or removal of, the article by a failure of the RFID tag to respond to the RFID interrogator device.

The method may include the further step of providing identifying information stored within the RFID tag prior to storing the article within the container. The step of of interrogating the RFID tag may then include reading the identifying information from the RFID tag, and the step of detecting unauthorised tampering may include detecting whether the identifying information has changed since the article was stored within the container. Advantageously, this makes it difficult for a tamperer to circumvent the system by replacing a damaged tag with an intact tag, since the identifying information stored within the replacement tag would not match the original identifying information, and the change could thus be detected.

The identifying information may be transmitted electronically from a first location at which the article is stored within the container to a second location at which the RFID tag is interrogated. Thus, detecting whether the identifying information has changed may include comparing the electronically transmitted identifying information with the identifying information read from the RFID tag.

Preferably the RFID tag further includes an adhesive coating applied to an outer surface thereof, to enable the tag to be affixed to an article. Advantageously, this enables the tag to be supplied in a completely self-contained form so that it may be directly applied to the article without need for the user to provide a separate means for affixing the tag to the article.

The RFID transponder may include a supporting substrate upon which the integrated circuit chip and antenna are mounted.

In preferred embodiments, the RFID tag further includes a first web of flexible material, with which the transponder is integrated, and the adhesive coating is applied to an outer surface of the first web of flexible material. Advantageously, the first web of flexible material provides additional mechanical support and protection for the transponder, and a larger surface area that may be more suitable for application of the adhesive coating.

Preferably, the RFID tag further includes a second web of flexible material, and the transponder is disposed between the first and second webs of flexible material in a laminar structure. The benefit of this structure is to provide superior mechanical support and protection for the transponder.

The first and second webs of flexible material may be made of paper. Alternatively, they may be made of a plastic such as polyvinylchloride (PVC).

In a particularly preferred embodiment, the line of weakness includes a line of perforations. Alternatively, the line of weakness may be formed in some other manner, such as by scoring the tag along the desired line. Preferably, the line of weakness is provided in the first and/or the second web of flexible material. However, in whichever manner the line of weakness is formed, it is important to ensure that the tag is not rendered inoperative, such as by severing a portion of the antenna or a connection to the integrated circuit chip.

The tag may further include one or more additional lines of weakness, each of which extends across at least a portion of the antenna or between the antenna and the integrated circuit chip, such that when the seal tag is broken along any one or more of the lines of weakness the RFID transponder is rendered unable to communicate with the RFID interrogator device. The provision of multiple lines of weakness advantageously improves the flexibility of application of the tag, enabling it to be applied across lines of opening of articles having a variety of different geometries.

While the RFID transponder may be either active or passive, it is preferred that a passive RFID transponder be used in order to minimise the cost and complexity of the RFID tag.

### BRIEF DESCRIPTION OF THE DRAWINGS

Further benefits and advantages of the RFID tag of the present invention will become apparent in the following description of preferred embodiments of the invention, which should not, however, be considered to limit the scope of the invention as described in any of the preceding statements. In order that the invention might be more fully understood, embodiments of the invention will be described with reference to the accompanying drawings, in which:

FIG. 1 shows an RFID tag in accordance with the invention;

FIG. 2 illustrates the use of the RFID tag shown in FIG. 1 to seal a package;

FIG. 3 is a diagrammatic flow chart illustrating a method for detecting unauthorised tampering with a package according to the invention; and

FIG. 4 shows an alternative embodiment of an RFID tag in accordance with the invention.

### DESCRIPTION OF PREFERRED EMBODIMENT

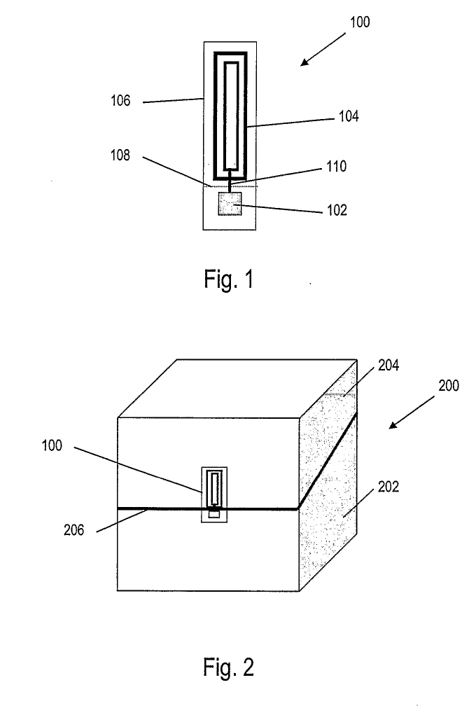

An embodiment of an RFID tag 100 for use as a tamper-evident seal in accordance with an aspect of the present invention is illustrated in FIG. 1. The RFID tag 100 includes an RFID transponder having an integrated circuit chip 102 and an antenna 104 connected to the integrated circuit chip. As is presently common in the art, the antenna 104 is formed as a coil antenna. The form of the RFID transponder is not critical to the invention, so long as it is sufficiently thin to be readily broken in the event of tampering with an article to which it is affixed. When intact, the RFID transponder is able to communicate with an RFID interrogator device that transmits a coded RF signal, by reflecting the incident RF carrier back to the interrogator, and encoding information stored in the memory of the integrated circuit chip 102 onto the carrier in the process. The transponder shown in FIG. 1 is a passive device, requiring no battery and instead deriving power from the RF signal used to interrogate the tag.

Suitable RFID transponders are commercially available from suppliers such as, for example, Texas Instruments. As will be appreciated by a person skilled in the art, commercial transponders are typically fabricated and supplied with the integrated circuit chip 102 and antenna 104 on an organic substrate (not shown in the figure) such as a polyester or polyimide. As shown in FIG. 1, the transponder is further integrated with at least one web of flexible material 106, which provides a backing giving additional strength and support to the tag during handling and application, as well as providing a suitable surface for the application of an adhesive coating. The backing material 106 may consist, for example, of either paper or a polymer material such as PVC.

In preferred embodiments, at least a second web of flexible material (not shown in the figure) may also be applied over the top of the transponder to provide additional protection during handling. The complete RFID tag 100 may thus be assembled via a lamination process wherein the transponder on its substrate is sandwiched between at least two webs of flexible material such as paper or plastic.

The back of the RFID tag is subsequently coated with a suitable adhesive, which is preferably a strong, pressure sensitive adhesive. A release layer such as a waxed paper or plastic film will typically be applied over the adhesive to maintain its active life, and prevent the tag from adhering prematurely to other articles or surfaces. The tag may then be affixed to an article by removing the release layer and pressing the adhesive surface of the tag onto the article in the desired location.

The RFID tag 100 also has a line of weakness in the form of a line of perforations 108 that extends across a metallic conductor 110 connecting the integrated circuit chip 102 with the antenna 104. It will be appreciated that the line of weakness need not take the form of perforations, but may be formed in any suitable manner such as, for example, scoring the tag along the desired line. In whichever manner the line of weakness is created, the essential requirements are that the tag be weakened so as to be more easily torn along the line, and that the transponder not be damaged in the process of creating the line. Thus, for example, in the case of the perforated line 108 perforations may be created immediately adjacent to the conductor 110, but care must be taken to ensure that no perforation is made in the conductor 110 itself.

In accordance with the invention, when the tag 100 is broken along the perforated line 110, the connection between the integrated circuit chip 102 and the antenna 104 will be severed, rendering the RFID transponder inoperable and unable to communicate with an RFID interrogator device. Acccordingly, possible breakage of the tag 100 along the line 1 10, may be detected by attempting to interrogate the transponder. If the transponder responds to interrogation, then it may be assumed that the tag 100 has not been broken.

FIG. 2 illustrates the manner in which the exemplary tag 100 may be used as a tamper evident seal on a package 200. As depicted in the drawing, the package 200 is a box having base 202 and a hinged lid 204 (the hinge being at the rear of the box, and not visible), such as a jewellery box. The box 200 therefore has a line of opening 206 running between the base 202 and the lid 204. The contents of the box 200 cannot be accessed without either damaging the box, or separating the base 202 and lid 204 along the line of opening 206 by opening the box in the usual manner.

The RFID tag 100 is applied as a tamper evident seal by adhering it across the base 202 and lid 204 of the box such that the perforated line 108 is aligned with the line of opening 206. Accordingly, if the box 200 is opened, the tag 100 will break along the perforated line 108, and any subsequent attempt to interrogate the tag 100 will receive no response, providing an indication that the contents of the box 200 may have been tampered with or removed.

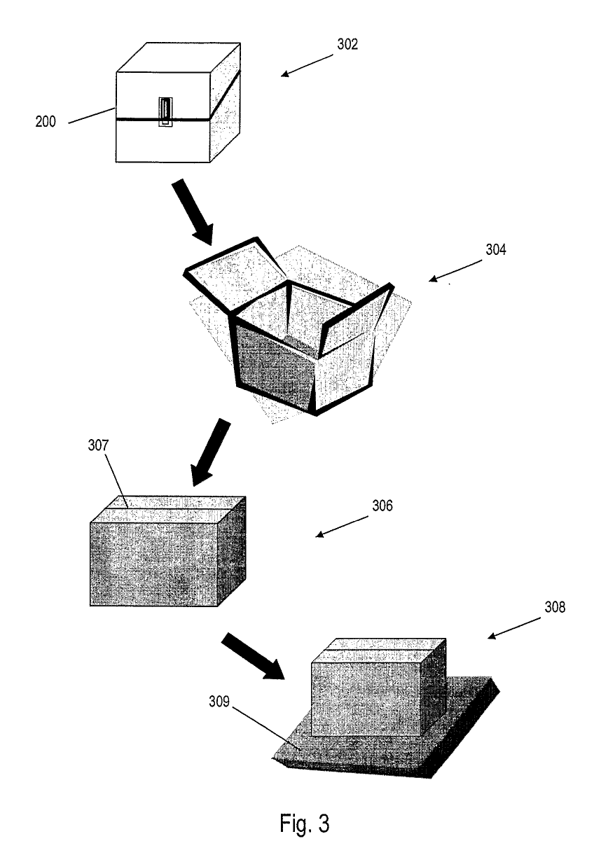

Advantageously, the interrogation of the tag 100 may be carried out without need for visual inspection even if the box 200 is enclosed within a larger container. Accordingly, FIG. 3 illustrates diagrammatically an exemplary method in accordance with the invention that enables the detection of unauthorised tampering with, or removal of, an article stored within a container.

In a first step 302 of the method, a box 200 containing an article of value, such as jewellery, is sealed using an RFID tag in accordance with the invention, in the manner previously described with reference to FIG. 2.

In a further step 304, the box 200 is enclosed within a larger container such as a cardboard shipping carton. The container may contain a number of individually tagged and sealed articles.

In a subsequent step 306, the container is sealed closed. It will be appreciated that a container such as a cardboard carton has a line of opening, e.g. 307, which may be sealed using ordinary packing tape, tamper resistant tape and/or a further RFID tag in accordance with the invention.

At any desired later stage 308 during shipping and handling, the contents of the container may be interrogated by an RFID interrogation device. For ease of handling, the interrogation device may, for example, be built into a surface 309 on which the container is placed, or over which the container passes, during normal processing. If all of the originally enclosed RFID tags respond to the interrogation device, it is reasonably certain that all of the corresponding articles are still enclosed within the container, and that the boxes, e.g. 200, have not been opened during handling or transit. On the other hand, failure of any of the originally enclosed RFID tags to respond to the interrogation device provides an indication that the corresponding article may have been removed and/or that the corresponding box may have been opened or otherwise tampered with. In either case, it is unnecessary to open the container or to visually inspect the contents unless an RFID tag fails to respond. Advantageously, since the container need not be opened unless tampering is already suspected, representatives of the sender, receiver or insurer of the goods may be called to be present, if desired, for the opening and inspection of the container.

To ensure security in shipment, the identifying information, otherwise known as the TagID, stored in each RFID tag may be separately transmitted, for example in electronic form, to the receiver. When the consignment is received, it is then possible for the receiver to ensure that there is an exact match between the TagID's obtained by interrogation of the RFID tags within the container and those received electronically. This ensures that not only is the number of responsive RFID tags within the container correct, but that each one contains the expected identifying information. Accordingly, it would not be possible for a tamperer to circumvent the system by replacing a damaged tag with an intact tag, since the TagID of the replacement tag would be incorrect.

Although it is plausible in principle that a sophisticated tamperer may read the TagID from an original tag, and program a replacement tag with the same TagID, in practice this would be difficult, since different tags may use different protocols to communicate, and thus the tamperer would need to know the correct protocol corresponding to the tag to be read. However, even greater security could be achieved through the use of secure protocols to communicate with the RFID tags.

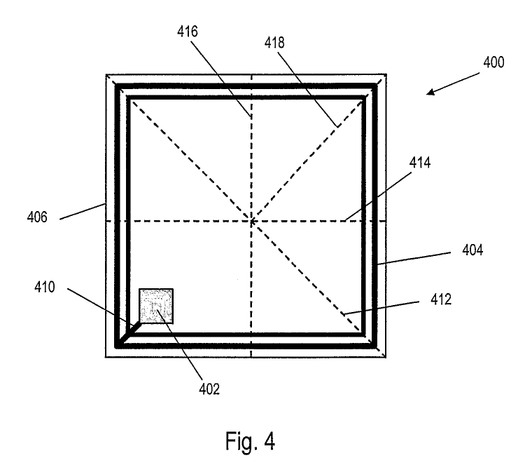

It will be appreciated by those skilled in the art that the RFID tag of the invention is not limited in form to the embodiment 100 described with reference to FIGS. 1 to 3. By way of further example only, an alternative embodiment 400 of the RFID tag is shown in FIG. 4. As with the embodiment 100, the RFID tag 400 also includes an RFID transponder having an integrated circuit chip 402 and a coil antenna 404 connected to the integrated circuit chip via a conductor 410. The transponder is integrated with at least one flexible web of backing material 406 such as paper or a plastic, which has an adhesive coating on the reverse surface. The integrated circuit chip 402 is located within the perimeter defined by the coils of the antenna 404, and thus in the embodiment 400 it is not practical or convenient to form a line of weakness across the connecting conductor 410.

Thus, in the case of the alternative embodiment 400, lines of weakness are instead formed across the coils of the antenna 404. Breakage of the antenna coils will also cause the transponder to become unresponsive to interrogation. Any line that will result in breakage of the antenna will thus serve the purpose of rendering the tag inoperative, and accordingly a number of lines of weakness are provided in the alternative embodiment 400. These include a complete diagonal line 412, a horizontal line 414, a vertical line 416 and a half diagonal line 418, each of which is formed as a line of perforations. The provision of multiple lines of weakness advantageously improves the flexibility of application of the tag, enabling it to be applied across lines of opening of articles having a variety of different geometries.

To provide an even higher level of protection for articles, especially those held in large packages that may have areas of weakness or that allow access from more than one side or opening, multiple tags may be applied across the various lines or possible areas of opening. If any one of the tags applied to the package is subsequently found to be unresponsive to interrogation, this will serve to indicate that the package may have been opened or otherwise tampered with.

The above described embodiments are not intended to be limiting of the invention, and other embodiments may be implemented within the scope of the invention as defined by the appended claims.

1. An RFID tag for use as a taper-evident seal, including:
an RFID transponder having an integrated circuit chip and an antenna connected to the integrated circuit chip, the transponder being able, when intact, to communicate with an RFID interrogator device, the RFID tag having a line of weakness extending across at least a portion of the antenna or between the antenna and the integrated circuit chip, such that when the tag is broken along the line of weakness the RFID transponder is rendered unable to communicate with the RFID interrogator device;
a first web of flexible material, having an adhesive coating applied to an outer surface thereof, to enable the tag to be affixed to an article; and
a second web of flexible material,
wherein the transponder is disposed between the first and second webs of material in a laminar structure.

2. An RFID tag according to claim 1 wherein the RFID transponder further includes a supporting substrate upon which the integrated circuit chip and antenna are mounted.

3. An RFID tag according to claim 1 wherein the first and second webs of flexible material are made of paper.

4. An RFID tag according to claim 1 wherein the first and second webs of flexible material are made of plastic.

5. An RFID tag according to claim 1 wherein the line of weakness includes a line of perforations.

6. An RFID tag according to claim 1 wherein the RFID transponder is a passive RFID transponder.

7. An RFID tag according to claim 1 wherein the line of weakness is provided in the first and/or second web of flexible material.

8. An RFID tag according to claim 1 further including one or more additional lines of weakness, each of which extends across at least a portion of the antenna or between the antenna and the integrated circuit chip, such that when the seal tag is broken along any one or more of the lines of weakness the RFID transponder is rendered unable to communicate with the RFID interrogator device.

9. An RFID tag according to claim 1 wherein the antenna is a coil antenna.

10. A method of sealing a package in order to enable the detection of unauthorised access to the contents of the package, including the steps of:
providing an RFID tag having an RFID transponder having an integrated circuit chip and an antenna connected to the integrated circuit chip, the transponder being able, when intact, to communicate with an RFID interrogator device, the RFID tag having a line of weakness extending across at least a portion of the antenna or between the antenna and the integrated circuit chip, such that when the tag is broken along the line of weakness the RFID transponder is rendered unable to communicate with the RFID interrogator device, a first web of flexible material, having an adhesive coating applied to an outer surface thereof, to enable the tag to be affixed to an article, and a second web of flexible material, wherein the transponder is disposed between the first and second webs of material in a laminar structure; and
affixing the RFID tag to the package by means of the adhesive coating applied to the first web of flexible material of the tag, such that the line of weakness of the tag is aligned with a line of opening of the package,
whereby, when the package is opened along said line of opening, the tag is broken along said line of weakness.

11. A method of sealing a package in order to enable the detection of unauthorised access to the contents of the package, including the steps of:
providing a plurality of RFID tags, each RFID tag having an RFID transponder having an integrated circuit chip and an antenna connected to the integrated circuit chip, the transponder being able, when intact, to communicate with an RFID interrogator device, the RFID tag having a line of weakness extending across at least a portion of the antenna or between the antenna and the integrated circuit chip, such that when the tag is broken along the line of weakness the RFID transponder is rendered unable to communicate with the RFID interrogator device, a first web of flexible material, having an adhesive coating applied to an outer surface thereof, to enable the tag to be affixed to an article, and a second web of flexible material, wherein the transponder is disposed between the first and second webs of material in a laminar structure; and
affixing the plurality of RFID tags to the package by means of the adhesive coating applied to the first webs of flexible material of the tags, such that the lines of weakness of the tags are aligned with one or more lines of opening of the package,
whereby, when the package is opened along any one or more of said lines of opening, at least one of the tags is broken along the line of weakness of the tag.

12. A method for detecting unauthorised tampering with, or removal of, an article stored within a container, including the steps of:
providing an RFID tag having an RFID transponder having an integrated circuit chip and an antenna connected to the integrated circuit chip, the transponder being able, when intact, to communicate with an RFID interrogator device, the RFID tag having a line of weakness extending across at least a portion of the antenna or between the antenna and the integrated circuit chip, such that when the tag is broken along the line of weakness the RFID transponder is rendered unable to communicate with the RFID interrogator device, a first web of flexible material, having an adhesive coating applied to an outer surface thereof, to enable the tag to be affixed to an article, and a second web of flexible material, wherein the transponder is disposed between the first and second webs of material in a laminar structure;
affixing the RFID tag to the article by means of the adhesive coating applied to the first web of flexible material of the tag;
storing the article within the container;
subsequently interrogating the RFID tag using an RFID interrogator device; and
detecting unauthorised tampering with, or removal of, the article by a failure of the RFID tag to respond to the RFID interrogator device.

13. A method according to claim 12 further including the step of providing identifying information stored within the RFID tag prior to storing the article within the container, and wherein the step of interrogating the RFID tag includes reading the identifying information from the RFID tag and the step of detecting unauthorised tampering includes detecting whether the identifying information has changed since the article was stored within the container.

14. A method according to claim 13 wherein the identifying information is transmitted electronically from a first location at which the article is stored within the container to a second location at which the RFID tag is interrogated, and detecting whether the identifying information has changed includes comparing the electronically transmitted identifying information with the identifying information read from the RFID tag.

15. A method according to claim 12 wherein the article is contained within a package, and the step of affixing the RFID tag to the article includes affixing the RFID tag to the package such that the line of weakness of the tag is aligned with a line of opening of the package, such that when the package is opened along said line of opening, the tag is broken along said line of weakness.

16. A method for detecting unauthorised tampering with, or removal of, an article stored within a container, including the steps of:
providing a plurality of RFID tags, each RFID tag having an integrated circuit chip and an antenna connected to the integrated circuit chip, the transponder being able, when intact, to communicate with an RFID interrogator device, the RFID tag having a line of weakness extending across at least a portion of the antenna or between the antenna and the integrated circuit chip, such that when the tag is broken along the line of weakness the RFID transponder is rendered unable to communicate with the RFID interrogator device, a first web of flexible material, having an adhesive coating applied to an outer surface thereof, to enable the tag to be affixed to an article, and a second web of flexible material, wherein the transponder is disposed between the first and second webs of material in a laminar structure;
affixing the plurality of RFID tags to the article by means of the adhesive coating applied to the first webs flexible material of the tags;
storing the article within the container;
subsequently interrogating the plurality of RFID tags using an RFID interrogator device; and
detecting unauthorised tampering with, or removal of, the article by a failure of one or more of the RFID tags to respond to the RFID interrogator device.

17. A method for detecting unauthorised tampering with, or removal of, an article stood within a container, including the steps of:
providing an RFID tag that includes an integrated circuit chip, an antenna connected to the integrated circuit chip, and a line of weakness extending across at least a portion of the antenna or between the antenna and the integrated circuit chip, such that when the tag is broken along said line of weakness the RFID transponder is rendered unable to communicate with a corresponding RFID interrogator device;
recording identifying information within the RFID tag;
affixing the RFID tag to the article, and storing the article within the container at a first location;
transmitting the identifying information electronically from the first location to a second location to which the container is transported;
interrogating the RFID tag at the second location using an RFID interrogation device to retrieve the identifying information stored therein; and
detecting unauthorised tampering with, or removal of, the article if either the RFID tag fails to respond to the RFID interrogator device or the retrieved identifying information does not correspond with the transmitted information.
